(19) United States
(12) Patent Application Publication
(10) Pub. No.: US 2024/0411317 A1
(43) Pub. Date: Dec. 12, 2024

(54) METHOD, APPARATUS FOR RETURN CONTROL OF SWIMMING POOL CLEANING ROBOT, AND ELECTRONIC DEVICE THEREOF

(71) Applicant: Suzhou Smorobot Technology Co., Ltd., Suzhou City (CN)

(72) Inventor: Zhongchao DING, Beijing (CN)

(73) Assignee: Suzhou Smorobot Technology Co., Ltd., Suzhou City (CN)

(21) Appl. No.: 18/807,174

(22) Filed: Aug. 16, 2024

Related U.S. Application Data
(63) Continuation of application No. PCT/CN2022/076900, filed on Feb. 18, 2022.

(51) Int. Cl. G05D 1/246; E04H 4/16; G05D 1/661; G05D 105/10; G05D 107/00

(52) U.S. Cl. CPC G05D 1/246; E04H 4/1654; G05D 1/661; G05D 2105/10; G05D 2107/29

(57) ABSTRACT

The present disclosure provides a method and apparatus for return control of a swimming pool cleaning robot, and an electronic device and a computer storage medium thereof. The method includes: in response to a trigger of a return instruction, acquiring a current position of the swimming pool cleaning robot in a map for a swimming pool; and generating a return path according to a reachable block in the map for the swimming pool, a predetermined return position, and the current position, and controlling the swimming pool cleaning robot to return from the current position to the predetermined return position on the basis of the return path. Therefore, the swimming pool cleaning robot is controlled to automatically return to a designated position of the swimming pool, such that use smartness of the swimming pool cleaning robot is improved, and use experience of a user is enhanced.

### CROSS-REFERENCE TO RELATED APPLICATION

This application is a continuation of International Application No. PCT/CN2022/076900 filed on Feb. 18, 2022, and entitled “METHOD, APPARATUS FOR RETURN CONTROL OF SWIMMING POOL CLEANING ROBOT, AND ELECTRONIC DEVICE THEREOF,” the contents of which is hereby incorporated by reference in its entirety.

### TECHNICAL FIELD

Embodiments of the present disclosure relate to the technical field of control of swimming pool cleaning robots, and in particular, relate to a method and apparatus for return control of a swimming pool cleaning robot, and an electronic device and a computer storage medium thereof.

### BACKGROUND

A swimming pool cleaning robot is developed for cleaning a swimming pool. The swimming pool cleaning robot may establish a map for the swimming pool corresponding to a work area of the swimming pool, and do cleaning for walls and bottom of the swimming pool on the basis of the map for the swimming pool.

In the related art, the swimming pool cleaning robot, upon completing a swimming pool map creation task and/or a swimming pool cleaning task, may reside at a random position in a swimming pool. In this case, it is possible that the swimming pool cleaning robot resides in central waters in the swimming pool. In addition, in the course of performing the swimming pool map creation task and/or the swimming pool cleaning task by the swimming pool cleaning robot, due to power insufficiency, a filter basket of the swimming pool cleaning robot may be clogged or the swimming pool cleaning robot may encounter an abrupt fault, and in this case, the swimming pool cleaning robot may reside in the central waters in the swimming pool due to exceptional interruption of the ongoing task. As a result, it is difficult to retrieve the swimming pool cleaning robot.

Therefore, an improved automatic return technique is desired for the swimming pool cleaning robot to retrieve the swimming pool cleaning robot.

### SUMMARY

To address the above technical problem, embodiments of the present disclosure provide a technique for return control of a swimming pool cleaning robot, which may at least partially solve the above technical problem.

According to one aspect of the present disclosure, a method for return control of a swimming pool cleaning robot is provided. The method includes: in response to a trigger of a return instruction, acquiring a current position of the swimming pool cleaning robot in a map fora swimming pool; and generating a return path according to a reachable block in the map for the swimming pool, a predetermined return position, and the current position, and controlling the swimming pool cleaning robot to return from the current position to the predetermined return position on the basis of the return path.

In one or more embodiments, the method further includes: determining the predetermined return position according to one of an initial position of the swimming pool cleaning robot, a position of a charging post for the swimming pool cleaning robot, and a designated position in the swimming pool.

In one or more embodiments, the initial position of the swimming pool cleaning robot is determined by: determining the initial position of the swimming pool cleaning robot according to a position at a bottom of the swimming pool to which the swimming pool cleaning robot freely sinks; or controlling the swimming pool cleaning robot to move, in response to a move instruction, to the designated position relative to the bottom of the swimming pool, and determining the designated position as the initial position of the swimming pool cleaning robot.

In one or more embodiments, the map for the swimming pool including the reachable block is generated by: determining a central position of the map for the swimming pool according to the initial position; generating, according to the central position, the map for the swimming pool covering a work area of the swimming pool and including a plurality of grid blocks; and controlling the swimming pool cleaning robot to move relative to the map for the swimming pool in the work area of the swimming pool, and determining each grid block reachable by the swimming pool cleaning robot in the map for the swimming pool as the reachable block.

In one or more embodiments, generating the return path according to the reachable block in the map for the swimming pool, the predetermined return position, and the current position, and controlling the swimming pool cleaning robot to return from the current position to the predetermined return position on the basis of the return path include: determining, according to the predetermined return position, the grid block corresponding to the predetermined return position in the map for the swimming pool as a return block; determining, according to the current position of the swimming pool cleaning robot, the grid block corresponding to the current position in the map for the swimming pool as a current block; generating, according to each reachable block in the map for the swimming pool, the return block, and the current block, the return path for moving from the current block to the return block; and controlling the swimming pool cleaning robot to move, on the basis of the return path, from the current block to the return block through at least one reachable block in the map for the swimming pool.

In one or more embodiments, generating, according to each reachable block in the map for the swimming pool, the return block, and the current block, the return path for moving from the current block to the return block includes: generating, according to each reachable block in the map for the swimming pool, the return block, and the current block, a shortest movement path between the current block and the return block by using a predetermined path-finding algorithm, and determining the shortest movement path as the return path.

In one or more embodiments, the predetermined path-finding algorithm includes an A-STAR algorithm.

In one or more embodiments, the trigger of the return instruction includes a system automatic trigger in response to fulfillment of a predetermined rule, or a manual trigger in response to a man-machine interactive input.

In one or more embodiments, the system automatic trigger in response to fulfillment of the predetermined rule includes at least one of: a system automatic trigger in response to detecting that the swimming pool cleaning robot completes a predetermined task, a system automatic trigger in response to detecting that a current power amount of the swimming pool cleaning robot is lower than a predetermined power amount threshold, a system automatic trigger in response to detecting that a clogging degree of a filter basket of the swimming pool cleaning robot satisfies a predetermined clogging condition, a system automatic trigger in response to detecting that the swimming pool cleaning robot encounters a fault, and a system automatic trigger in response to detecting that a running duration of the swimming pool cleaning robot satisfies a predetermined duration.

According to another aspect of the present disclosure, an apparatus for return control of a swimming pool cleaning robot is provided. The apparatus includes: a current position determining module, configured to, in response to a trigger of a return instruction, acquire a current position of the swimming pool cleaning robot in a map for a swimming pool; and a return control module, configured to generate a return path according to a reachable block in the map for the swimming pool, a predetermined return position, and the current position, and control the swimming pool cleaning robot to return from the current position to the predetermined return position on the basis of the return path.

According to still another aspect of the present disclosure, an electronic device is provided. The electronic device includes: a processor; and a memory storing a program therein; wherein the program includes one or more instructions, and the processor, when executing the one or more instructions, is caused to perform the method as described above.

According to yet still another aspect of the present disclosure, a non-transitory computer-readable storage medium storing one or more computer instructions therein is provided, wherein the one or more computer instructions, when executed by a computer, cause the computer to perform the method as described above.

In the technical solutions of return control of the swimming pool cleaning robot according to the present disclosure, in response to the trigger of the return instruction, the swimming pool cleaning robot is controlled to return from the current position to the predetermined return position in the swimming pool based on the generated return path, such that the swimming pool cleaning robot is retrieved or charged at the predetermined return position. In this way, use smartness of the swimming pool cleaning robot is improved, development cost is reduced, and operations are simplified.

### BRIEF DESCRIPTION OF THE DRAWINGS

The accompanying drawings are merely for schematic description and demonstration of the present disclosure, instead of limiting the scope of the present disclosure.

FIG. 1 is a schematic flowchart of a method for return control of a swimming pool cleaning robot according to one exemplary embodiment of the present disclosure;

FIG. 2 is a schematic flowchart of a method for return control of a swimming pool cleaning robot according to another exemplary embodiment of the present disclosure;

FIG. 3 is a schematic structural block diagram of an apparatus for return control of a swimming pool cleaning robot according to one exemplary embodiment of the present disclosure; and

FIG. 4 is a schematic structural block diagram of an electronic device according to one exemplary embodiment of the present disclosure.

Reference numerals and denotations thereof:
300—apparatus for return control of swimming pool cleaning robot; 302—current position determining module; 304—return control module; 400—electronic device; 401—computing unit; 402—ROM; 403—RAM; 404—bus; 405—input/output interface; 406—input unit; 407—output unit; 408—storage unit; and 409—communication unit.

### DETAILED DESCRIPTION

For clearer descriptions of the technical features, objectives, and the technical effects of the embodiments of the present disclosure, specific embodiments of the present disclosure are hereinafter described with reference to the accompanying drawings.

In this text, the term “exemplary” or “schematic” is used herein to mean “serving as an example, instance, or illustration,” and any illustration or embodiment described herein as “exemplary” shall not be necessarily construed as preferred or advantageous over other illustrations or embodiments.

For brevity, parts relevant to the present disclosure are merely illustrated in the drawings, and these parts do not denote the actual structure of the product. In addition, for brevity and ease of understanding, with respect to parts having the same structure or function in the drawings, one or more of these parts are illustratively drawn in the drawings, or one or more of these parts are marked.

A conventional swimming pool cleaning robot, upon completing a swimming pool map creation task and/or a swimming pool cleaning task, may reside at a random position in a swimming pool. In this case, it is possible that the swimming pool cleaning robot resides in central waters in the swimming pool. Alternatively, in the course of performing the swimming pool map creation task and/or the swimming pool cleaning task, due to power insufficiency, a filter basket of the swimming pool cleaning robot may be clogged or the swimming pool cleaning robot may encounter an abrupt fault, and in this case, the swimming pool cleaning robot may reside in the central waters in the swimming pool due to exceptional interruption of the ongoing task. As a result, it is difficult to retrieve the swimming pool cleaning robot.

Accordingly, the present disclosure provides an improved method and apparatus for return control of the swimming pool cleaning robot, and an electronic device and a computer storage medium thereof, which may solve the problems in the related art.

The specific embodiments of the present disclosure are described in detail hereinafter with reference to the accompanying drawings.

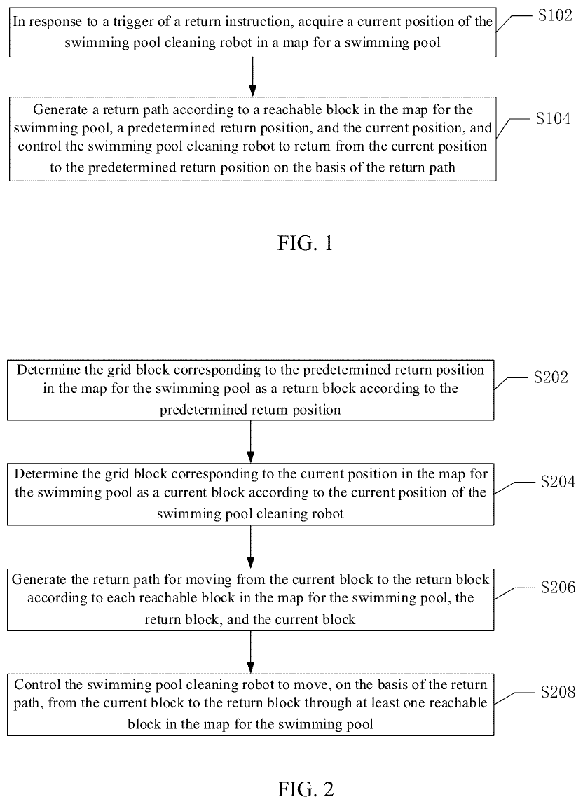

FIG. 1 is a schematic flowchart of a method for return control of a swimming pool cleaning robot according to one exemplary embodiment of the present disclosure. As illustrated in FIG. 1, this embodiment mainly includes the following steps:

In step S102, a current position of the swimming pool cleaning robot in a map for a swimming pool is acquired in response to a trigger of a return instruction.

Optionally, the trigger of the return instruction includes a system automatic trigger in response to fulfillment of a predetermined rule, or a manual trigger in response to a man-machine interactive input.

In this embodiment, the system automatic trigger in response to fulfillment of the predetermined rule may include, but is not limited to: a system automatic trigger in response to detecting that the swimming pool cleaning robot completes a predetermined task, a system automatic trigger in response to detecting that a current power amount of the swimming pool cleaning robot is lower than a predetermined power amount threshold, a system automatic trigger in response to detecting that a clogging degree of a filter basket of the swimming pool cleaning robot satisfies a predetermined clogging condition, a system automatic trigger in response to detecting that the swimming pool cleaning robot encounters a fault, and a system automatic trigger in response to detecting that a running duration of the swimming pool cleaning robot satisfies a predetermined duration.

For example, in the case that the swimming pool cleaning robot completes one or more predetermined tasks in the swimming pool, generation of the return instruction is triggered.

Still for example, in the course of performing various tasks in the swimming pool by the swimming pool cleaning robot, generation of the return instruction is triggered in response to detecting that the current power amount of the swimming pool cleaning robot is lower than the predetermined power amount threshold, or detecting that the swimming pool cleaning robot encounters the fault, or detecting that the filter basket of the swimming pool cleaning robot is severely clogged.

Still for example, a predetermined running duration of the swimming pool cleaning robot may be defined. Generation of the return instruction is triggered in response to detecting that an actual running duration of the swimming pool cleaning robot satisfies the predetermined running duration.

In step S104, a return path is generated according to a reachable block in the map for the swimming pool, a predetermined return position, and the current position, and the swimming pool cleaning robot is controlled to return from the current position to the predetermined return position on the basis of the return path.

Optionally, the predetermined return position may be determined according to an initial position of the swimming pool cleaning robot, a position of a charging post for the swimming pool cleaning robot, and a designated position in the swimming pool.

In one embodiment, the initial position of the swimming pool cleaning robot may be determined according to a position at a bottom of the swimming pool to which the swimming pool cleaning robot freely sinks.

For example, the position at the bottom of the swimming pool to which the swimming pool cleaning robot freely sinks when being placed into the swimming pool along a wall of the swimming pool may be determined as the initial position of the swimming pool cleaning robot.

In another embodiment, the swimming pool cleaning robot is controlled to move, in response to a move instruction, to the designated position relative to the bottom of the swimming pool, and the designated position is determined as the initial position of the swimming pool cleaning robot.

For example, in the case that the swimming pool cleaning robot freely sinks to the bottom of the swimming pool, the swimming pool cleaning robot to may be controlled to move, in response to the move instruction, to the designated position expected by a user relative to the bottom of the swimming pool, and the designated position is determined as the initial position of the swimming pool cleaning robot.

Therefore, in the case that the initial position of the swimming pool cleaning robot is determined as the return position, a user may conveniently retrieve the swimming pool cleaning robot from the swimming pool; and in the case that the position of the charging post for the swimming pool cleaning robot is determined as the return position, the swimming pool cleaning robot may automatically return to the charging post and may be charged at the charging post.

In this embodiment, the designated position of the swimming pool is a position designated in the swimming pool based on a man-machine interaction instruction.

In addition, in the case that the swimming pool cleaning robot encounters the fault or the power amount of the swimming pool cleaning robot is less than the predetermined power amount threshold, an edge position, in the swimming pool, adjacent to the current position of the swimming pool cleaning robot may be designated as the return position.

Optionally, the map for the swimming pool including a plurality of reachable blocks is generated by:
determining a central position of the map for the swimming pool according to the initial position of the swimming pool cleaning robot; generating, according to the central position, the map for the swimming pool covering a work area of the swimming pool and including a plurality of grid blocks; and controlling the swimming pool cleaning robot to move relative to the map for the swimming pool in the work area of the swimming pool, and determining each grid block reachable by the swimming pool cleaning robot in the map for the swimming pool as the reachable block.

Specifically, a central coordinate point of the map for the swimming pool may be determined according to the initial position of the swimming pool cleaning robot, and the map for the swimming pool covering the work area of the swimming pool may be generated according to the central coordinate point.

In this embodiment, coordinate values of the central coordinate point may be determined according to a predetermined size of the map for the swimming pool, and coordinate values of each grid block in the map for the swimming pool are made not less than 0.

For example, in the case that the size of the map for the swimming pool is 101×101, the coordinate values of the central coordinate point of the map for the swimming pool are defined as (50, 50), such that the coordinate values of each grid block in the map for the swimming pool are not less than 0 for correct recognition by the system.

In this embodiment, the return path from the current position to the predetermined return position may be generated according to various reachable blocks in the map for the swimming pool, and hence the swimming pool cleaning robot is controlled to return to the predetermined return position.

In summary, in the method for return control of the swimming pool cleaning robot according to this embodiment, in response to detecting the trigger of the return instruction, the return path is generated according to the current position of the swimming pool cleaning robot and the predetermined return position, and hence the swimming pool cleaning robot is driven to move and return from the current position to the predetermined return position, such that the swimming pool cleaning robot is retrieved or charged at the predetermined return position. In this way, use smartness of the swimming pool cleaning robot is improved, and use experience of the user is enhanced.

FIG. 2 is a schematic flowchart of a method for return control of a swimming pool cleaning robot according to another exemplary embodiment of the present disclosure. This embodiment illustrates a specific implementation solution of step S104. As illustrated in FIG. 2, this embodiment mainly includes the following steps:

In step S202, the grid block corresponding to the predetermined return position in the map for the swimming pool is determined as a return block according to the predetermined return position.

Optionally, the predetermined return position may include the initial position when the swimming pool cleaning robot drops into the water, the position of the charging post for the swimming pool cleaning robot, or the designated position in the swimming pool.

In step S204, the grid block corresponding to the current position in the map for the swimming pool is determined as a current block according to the current position of the swimming pool cleaning robot.

In this embodiment, the current position of the swimming pool cleaning robot in the map for the swimming pool may be simultaneously updated according to a movement trajectory of the swimming pool cleaning robot relative to the map for the swimming pool.

In step S206, the return path for moving from the current block to the return block is generated according to each reachable block in the map for the swimming pool, the return block, and the current block.

In this embodiment, a shortest movement path between the current block and the return block may be generated according to each reachable block in the map for the swimming pool, the return block, and the current block, by using the predetermined path-finding algorithm, and the shortest movement path may be determined as the return path.

Optionally, the predetermined path-finding algorithm may include, but is not limited to, an A-STAR algorithm.

In step S208, the swimming pool cleaning robot is controlled to move, on the basis of the return path, from the current block to the return block through at least one reachable block in the map for the swimming pool.

In summary, according to the embodiment of the present disclosure, by using the predetermined path-finding algorithm, an optimal movement path for returning from the current position to the predetermined return position is calculated based on the reachable block in the map for the swimming pool. In this way, the swimming pool cleaning robot is capable of quickly and safely returning, and thus the operation is simple and safe.

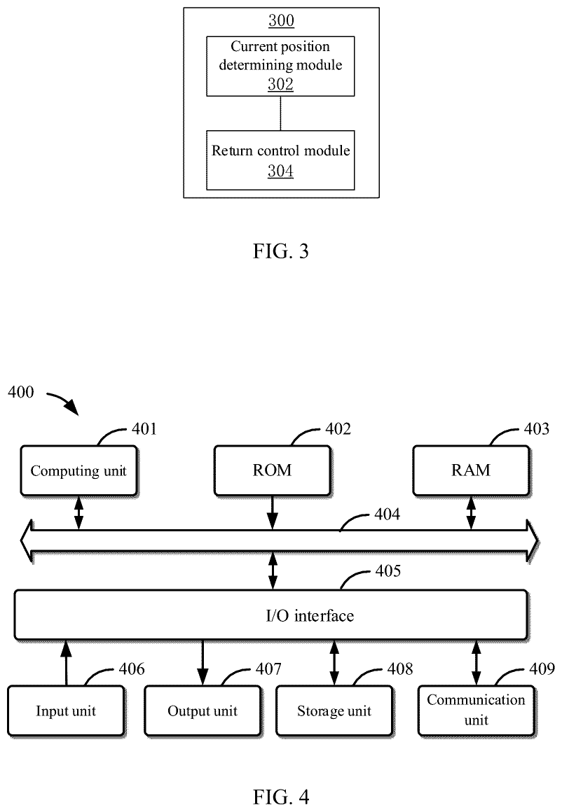

FIG. 3 is a schematic structural block diagram of an apparatus for return control of a swimming pool cleaning robot according to one exemplary embodiment of the present disclosure. As illustrated in FIG. 3, the apparatus 300 for return control of the swimming pool cleaning robot mainly includes:
a current position determining module 302, configured to, in response to a trigger of a return instruction, acquire a current position of the swimming pool cleaning robot in a map for a swimming pool; and
a return control module 304, configured to generate a return path according to a reachable block in the map for the swimming pool, a predetermined return position, and the current position, and control the swimming pool cleaning robot to return from the current position to the predetermined return position on the basis of the return path.

Optionally, the return control module 304 is further configured to: determine the predetermined return position according to one of an initial position of the swimming pool cleaning robot, a position of a charging post for the swimming pool cleaning robot, and a designated position in the swimming pool.

Optionally, the initial position of the swimming pool cleaning robot is determined by: determining the initial position of the swimming pool cleaning robot according to a position at a bottom of the swimming pool to which the swimming pool cleaning robot freely sinks; or controlling the swimming pool cleaning robot to move, in response to a move instruction, to the designated position relative to the bottom of the swimming pool, and determining the designated position as the initial position of the swimming pool cleaning robot.

Optionally, the map for the swimming pool including the reachable block is generated by: determining a central position of the map for the swimming pool according to the initial position; generating, according to the central position, the map for the swimming pool covering a work area of the swimming pool and including a plurality of grid blocks; and controlling the swimming pool cleaning robot to move relative to the map for the swimming pool in the work area of the swimming pool, and determining each grid block reachable by the swimming pool cleaning robot in the map for the swimming pool as the reachable block.

Optionally, the return control module 304 is further configured to: determine, according to the predetermined return position, the grid block corresponding to the predetermined return position in the map for the swimming pool as a return block; determine, according to the current position of the swimming pool cleaning robot, the grid block corresponding to the current position in the map for the swimming pool as a current block; generating, according to each reachable block in the map for the swimming pool, the return block, and the current block, the return path for moving from the current block to the return block; and control the swimming pool cleaning robot to move, on the basis of the return path, from the current block to the return block through at least one reachable block in the map for the swimming pool.

Optionally, the return control module 304 is further configured to: generate, according to each reachable block in the map for the swimming pool, the return block, and the current block, a shortest movement path between the current block and the return block by using the predetermined path-finding algorithm, and determine the shortest movement path as the return path.

Optionally, the predetermined path-finding algorithm includes an A-STAR algorithm.

Optionally, the trigger of the return instruction includes a system automatic trigger in response to fulfillment of a predetermined rule, or a manual trigger in response to a man-machine interactive input.

Optionally, the system automatic trigger in response to fulfillment of the predetermined rule includes at least one of: a system automatic trigger in response to detecting that the swimming pool cleaning robot completes a predetermined task, a system automatic trigger in response to detecting that a current power amount of the swimming pool cleaning robot is lower than a predetermined power amount threshold, a system automatic trigger in response to detecting that a clogging degree of a filter basket of the swimming pool cleaning robot satisfies a predetermined clogging condition, a system automatic trigger in response to detecting that the swimming pool cleaning robot encounters a fault, and a system automatic trigger in response to detecting that a running duration of the swimming pool cleaning robot satisfies a predetermined duration.

The apparatus 300 for return control of the swimming pool cleaning robot according to the embodiments of the present disclosure may be employed to perform the other steps of the methods for return control of the swimming pool cleaning robot as described above, and achieves corresponding beneficial effects that have been achieved by the method embodiments, which are not described herein any further.

An exemplary embodiment of the present disclosure further provides an electronic device. The electronic device includes: at least one processor and a memory communicably connected to the at least one processor. The memory stores a computer program runnable by the at least one processor, wherein the computer program, when run by the at least one processor, causes the electronic device to perform the methods according to the embodiments of the present disclosure.

An exemplary embodiment of the present disclosure further provides a non-transitory computer-readable storage medium storing a computer program therein, wherein the computer program, when run by a processor of a computer, causes the computer to perform the methods according to the embodiments of the present disclosure.

An exemplary embodiment of the present disclosure further provides a computer program product including a computer program therein, wherein the computer program, when run by a processor of a computer, causes the computer to perform the methods according to the embodiments of the present disclosure.

Referring to FIG. 4, a structural block diagram of an electronic device 400 which may serve as a server or a client according to the present disclosure is described, which is an example of a hardware device applicable to various aspects of the present disclosure. The electronic device is intended to represent digital and electronic computer devices in various forms, for example, a laptop computer, a tablet computer, a work station, a personal digital assistance, a server, a blade server, a large-scale computer, and any other suitable computer. The electronic device may also represent mobile devices in various forms, for example, a personal processing device, a cellular phone, a smart phone, a wearable device, and any other similar computing device. The parts or members described in this text, connections and relationships therebetween, and functions thereof are only exemplarily illustrated, instead of causing any limitation to practice described and/or required in this text for the present disclosure.

As illustrated in FIG. 4, the electronic device 400 includes a computing unit 401. The computing device 402, when running a computer program stored in a read-only memory (ROM) 402 or a computer program loaded from a storage unit 408 to a random-access memory (RAM) 403, is caused to perform suitable actions and operations. The RAM 403 may also store various programs and data desired by the operations of the electronic device 400. The computing unit 401, the ROM 402 and the RAM 403 are connected to each other via a bus 404. An input/output (I/O) interface 405 is also connected to the bus 404.

A plurality of units in the electron device 400 are connected to the I/O interface 405. The units include an input unit 406, an output unit 407, a storage unit 408, and a communication unit 409. The input unit 406 may be any type of device capable of inputting information into the electronic device 400. The input unit 406 may receive input digital or character information and generate key signal inputs related to user settings and/or function control of the electronic device. The output unit 407 may be any type of device capable of displaying information. The output unit 407 may include, but is not limited to, a display, a loudspeaker, a video/audio output terminal, a vibrator, and/or a printer. The storage unit 404 may include, but is not limited to, a magnetic disk and an optical disk. The communication unit 409 allows the electronic device 400 to exchange information/data with other devices over a computer network, for example, the Internet, and/or various telecommunication networks. The communication unit 409 may include, but is not limited to, a modem, a network card, an infrared communication device, a wireless communication transceiver, and/or a chip set, for example, a Bluetooth™ device, a Wi-Fi device, a WiMAX device, a cellular communication device, and/or analogs.

The computing unit 401 may be any universal and/or dedicated processing component having processing and computing capabilities. Some examples of the computing unit 401 include, but are not limited to, a central processing unit (CPU), a graphics processing unit (GPU), any dedicated Artificial Intelligence (AI) computing chip, any computing unit running a machine learning model algorithm, a digital signal processor (DSP), and any suitable processor, controller, micro controller unit, or the like. The computing unit 401 performs the methods and operations as described above. For example, in some embodiments, the method for return control of the swimming pool cleaning robot as described in the above embodiments may be practiced as a computer software program, which is tangibly embodied in a machine-readable medium, for example, the storage unit 408. In some embodiments, some or all of the computer programs may be loaded and/or installed onto the electronic device 400 via the ROM 402 and/or the communication unit 409. In some embodiments, the computing unit 401 may be configured, in any suitable fashion (for example, by virtue of firmware), to perform the method for return control of the swimming pool cleaning robot.

Program codes for implementing the method of the present disclosure may be written in any combination of one or more programming languages. These program codes may be provided to a processor or controller of a general purpose computer, special purpose computer or other programmable data processing apparatus such that the program codes, when executed by the processor or controller, enables the functions/operations specified in the flowcharts and/or block diagrams being implemented. The program codes may be executed entirely on the machine, partly on the machine, as a stand-alone software package partly on the machine and partly on the remote machine, or entirely on the remote machine or server.

In the context of the present disclosure, the machine-readable medium may be a tangible medium that may contain or store programs for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine readable storage medium may include an electrical connection based on one or more wires, a portable computer disk, a hard disk, a RAM, a ROM, an erasable programmable read-only memory (EPROM or a flash memory), an optical fiber, a portable compact disk read-only memory (CD-ROM), an optical storage device, a magnetic storage device, or any suitable combination thereof.

As used herein, the term “machine-readable medium” and “computer-readable medium” refer to any computer program product, apparatus and/or device, for example, a magnetic disk, an optical disk, a memory, and a programmable logic device (PLD), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, one or more aspects or features of the subject matter described herein can be implemented on a computer having a display device, for example a cathode ray tube (CRT) or a liquid crystal display (LCD) or a light emitting diode (LED) monitor for displaying information to the user and a keyboard and a pointing device, for example a mouse or a trackball, by which the user may provide input to the computer. Other types of devices may be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of the communication network include a local area network (LAN), a wide area network (WAN), and the Internet.

The computer system may include a client and a server. The client and the server are deployed distally from each other, and generally communicate and interact with each other over a communication network. The relationship of client and server arises by virtue of computer programs running on the respective computers and having a client-server relationship to each other.

It should be understood that, although this specification is described based on the embodiments, not each of the embodiments discloses an independent technical solution. Such description manner of the specification is only for clarity. A person skilled in the art should consider the specification as an entirety. The technical solutions according to the embodiments may also be suitably combined to derive other embodiments that may be understood by a person skilled in the art.

Described above are merely exemplary specific embodiments of the present disclosure, instead of causing any limitation to the scope of the embodiments of the present disclosure. Any person skilled in the art would derive equivalent variations, modifications, and combinations without departing from the concept and principle of the embodiments of the present disclosure, and these variations, modifications, and combinations shall fall within the scope of projection of the embodiments of the present disclosure.

What is claimed is:

1. A method for return control of a swimming pool cleaning robot, comprising:
in response to a trigger of a return instruction, acquiring a current position of the swimming pool cleaning robot in a map for a swimming pool;
generating a return path according to a reachable block in the map for the swimming pool, a predetermined return position and the current position; and
controlling the swimming pool cleaning robot to return from the current position to the predetermined return position on the basis of the return path.

2. The method according to claim 1, further comprising:
determining the predetermined return position according to one of an initial position of the swimming pool cleaning robot, a position of a charging post for the swimming pool cleaning robot and a designated position in the swimming pool.

3. The method according to claim 2, wherein the initial position of the swimming pool cleaning robot is determined by:
determining the initial position of the swimming pool cleaning robot according to a position at a bottom of the swimming pool to which the swimming pool cleaning robot freely sinks; or
controlling the swimming pool cleaning robot to move, in response to a move instruction, to the designated position relative to the bottom of the swimming pool, and determining the designated position as the initial position of the swimming pool cleaning robot.

4. The method according to claim 2, wherein the map for the swimming pool comprising the reachable block is generated by:
determining a central position of the map for the swimming pool according to the initial position;
generating, according to the central position, the map for the swimming pool covering a work area of the swimming pool and comprising a plurality of grid blocks;
controlling the swimming pool cleaning robot to move relative to the map for the swimming pool in the work area of the swimming pool; and
determining each grid block reachable by the swimming pool cleaning robot in the map for the swimming pool as the reachable block.

5. The method according to claim 4, wherein the generating the return path according to the reachable block in the map for the swimming pool, the predetermined return position and the current position, and the controlling the swimming pool cleaning robot to return from the current position to the predetermined return position on the basis of the return path comprise:
determining, according to the predetermined return position, the grid block corresponding to the predetermined return position in the map for the swimming pool as a return block;
determining, according to the current position of the swimming pool cleaning robot, the grid block corresponding to the current position in the map for the swimming pool as a current block;
generating, according to each reachable block in the map for the swimming pool, the return block and the current block, the return path for moving from the current block to the return block; and
controlling the swimming pool cleaning robot to move, on the basis of the return path, from the current block to the return block through at least one reachable block in the map for the swimming pool.

6. The method according to claim 5, wherein the generating, according to each reachable block in the map for the swimming pool, the return block and the current block, the return path for moving from the current block to the return block comprises:
generating, according to each reachable block in the map for the swimming pool, the return block and the current block, a shortest movement path between the current block and the return block as the return path by using a predetermined path-finding algorithm.

7. The method according to claim 6, wherein the predetermined path-finding algorithm comprises an A-STAR algorithm.

8. The method according to claim 1, wherein the trigger of the return instruction comprises a system automatic trigger in response to fulfillment of a predetermined rule, or a manual trigger in response to a man-machine interactive input.

9. The method according to claim 8, wherein the system automatic trigger in response to fulfillment of the predetermined rule comprises at least one of: a system automatic trigger in response to detecting that the swimming pool cleaning robot completes a predetermined task, a system automatic trigger in response to detecting that a current power amount of the swimming pool cleaning robot is lower than a predetermined power amount threshold, a system automatic trigger in response to detecting that a clogging degree of a filter basket of the swimming pool cleaning robot satisfies a predetermined clogging condition, a system automatic trigger in response to detecting that the swimming pool cleaning robot encounters a fault, and a system automatic trigger in response to detecting that a running duration of the swimming pool cleaning robot satisfies a predetermined duration.

10. An electronic device, comprising:
a processor; and
a memory storing a program,
wherein the program comprises one or more instructions, and the processor, when executing the one or more instructions, is caused to perform operations of:
in response to a trigger of a return instruction, acquiring a current position of the swimming pool cleaning robot in a map for a swimming pool;
generating a return path according to a reachable block in the map for the swimming pool, a predetermined return position and the current position; and
controlling the swimming pool cleaning robot to return from the current position to the predetermined return position on the basis of the return path.

11. The electronic device according to claim 10, wherein the processor, when executing the one or more instructions, is caused to further perform operations of:
determining the predetermined return position according to one of an initial position of the swimming pool cleaning robot, a position of a charging post for the swimming pool cleaning robot and a designated position in the swimming pool.

12. The electronic device according to claim 11, wherein the initial position of the swimming pool cleaning robot is determined by:
determining the initial position of the swimming pool cleaning robot according to a position at a bottom of the swimming pool to which the swimming pool cleaning robot freely sinks; or
controlling the swimming pool cleaning robot to move, in response to a move instruction, to the designated position relative to the bottom of the swimming pool, and determining the designated position as the initial position of the swimming pool cleaning robot.

13. The electronic device according to claim 11, wherein the map for the swimming pool comprising the reachable block is generated by:
determining a central position of the map for the swimming pool according to the initial position;
generating, according to the central position, the map for the swimming pool covering a work area of the swimming pool and comprising a plurality of grid blocks;
controlling the swimming pool cleaning robot to move relative to the map for the swimming pool in the work area of the swimming pool; and
determining each grid block reachable by the swimming pool cleaning robot in the map for the swimming pool as the reachable block.

14. The electronic device according to claim 13, wherein the generating the return path according to the reachable block in the map for the swimming pool, the predetermined return position and the current position, and the controlling the swimming pool cleaning robot to return from the current position to the predetermined return position on the basis of the return path comprise:
determining, according to the predetermined return position, the grid block corresponding to the predetermined return position in the map for the swimming pool as a return block;
determining, according to the current position of the swimming pool cleaning robot, the grid block corresponding to the current position in the map for the swimming pool as a current block;
generating, according to each reachable block in the map for the swimming pool, the return block and the current block, the return path for moving from the current block to the return block; and
controlling the swimming pool cleaning robot to move, on the basis of the return path, from the current block to the return block through at least one reachable block in the map for the swimming pool.

15. The electronic device according to claim 14, wherein the generating, according to each reachable block in the map for the swimming pool, the return block and the current block, the return path for moving from the current block to the return block comprises:
generating, according to each reachable block in the map for the swimming pool, the return block and the current block, a shortest movement path between the current block and the return block as the return path by using a predetermined path-finding algorithm.

16. The electronic device according to claim 15, wherein the predetermined path-finding algorithm comprises an A-STAR algorithm.

17. The electronic device according to claim 10, wherein the trigger of the return instruction comprises a system automatic trigger in response to fulfillment of a predetermined rule, or a manual trigger in response to a man-machine interactive input.

18. The electronic device according to claim 17, wherein the system automatic trigger in response to fulfillment of the predetermined rule comprises at least one of: a system automatic trigger in response to detecting that the swimming pool cleaning robot completes a predetermined task, a system automatic trigger in response to detecting that a current power amount of the swimming pool cleaning robot is lower than a predetermined power amount threshold, a system automatic trigger in response to detecting that a clogging degree of a filter basket of the swimming pool cleaning robot satisfies a predetermined clogging condition, a system automatic trigger in response to detecting that the swimming pool cleaning robot encounters a fault, and a system automatic trigger in response to detecting that a running duration of the swimming pool cleaning robot satisfies a predetermined duration.

19. A non-transitory computer-readable storage medium storing one or more computer instructions, wherein the one or more computer instructions, when executed by a computer, cause the computer to perform operations of:
in response to a trigger of a return instruction, acquiring a current position of the swimming pool cleaning robot in a map for a swimming pool;
generating a return path according to a reachable block in the map for the swimming pool, a predetermined return position and the current position; and
controlling the swimming pool cleaning robot to return from the current position to the predetermined return position on the basis of the return path.
